(19) United States
(12) Patent Application Publication
(10) Pub. No.: US 2022/0186074 A1
(43) Pub. Date: Jun. 16, 2022

(54) POWDERED MATERIAL (P) CONTAINING POLY(ARYLENE SULFIDE) (PAS) POLYMER AND ITS USE FOR ADDITIVE MANUFACTURING

(71) Applicant: SOLVAY SPECIALTY POLYMERS USA, LLC, Alpharetta, GA (US)

(72) Inventors: Christopher WARD, Sandy Springs, GA (US); Stéphane JEOL, Saint-Genis-Laval (FR); Brittany GILKENSON, Sandy Springs, GA (US); Hong CHEN, Alpharetta, GA (US)

(21) Appl. No.: 17/605,256

(22) PCT Filed: Apr. 7, 2020
(86) PCT No.: PCT/EP2020/059940

§ 371 Date: Oct. 21, 2021

Related U.S. Application Data
(60) Provisional application No. 62/838,993, filed on Apr. 26, 2019.

(30) Foreign Application Priority Data
Jun. 6, 2019 (EP) 19178736.5

(51) Int. Cl. C09D 181/02; C08J 3/12; C08G 75/0204; C08G 75/029; C08G 75/20; C08L 81/02; B33Y 70/00; B33Y 10/00; B29C 64/153

(52) U.S. Cl. CPC C09D 181/02; C08J 3/12; C08G 75/0204; C08G 75/029; C08G 75/20; C08L 81/02; B29K 2081/04; B33Y 10/00; B29C 64/153; C08L 2205/02; C08J 2381/02; C08J 2481/02; B33Y 70/00

(57) ABSTRACT

The present invention relates to a powdered material (M) containing at least one poly(arylene sulfide) (PAS) polymer, comprising recurring units p, q and r according of formula (I) wherein nₚ, n_{q} and nᵣ are respectively the mole % of each recurring units p, q and r; recurring units p, q and r are arranged in blocks, in alternation or randomly; 2≤(n_{q}+nᵣ)/(nₚ+n_{q}+nᵣ)≤9; nq is ≥0% and nr is ≥0%; j is zero or an integer varying between 1 and 4; R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

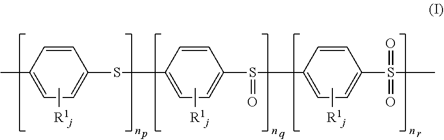

### RELATED APPLICATIONS

This application claims priority to U.S. No. 62/838,993 filed on Apr. 26, 2019 and to Europe No. 19178736.5 filed on Jun. 6, 2019, the whole content of each of these applications being incorporated herein by reference for all purposes.

### TECHNICAL FIELD

The present invention relates to a powdered material (M) containing at least one poly(arylene sulfide) (PAS) polymer and a process for manufacturing a three-dimensional (3D) article, part or composite material, from such powdered material (M). The present invention also relates to the 3D article, part or composite material obtainable from such process, as well as the use of the article, part or composite materials in oil and gas applications, automotive applications, electric and electronic applications, or aerospace and consumer goods.

### BACKGROUND ART

Many objects, from household items to motor parts, are produced either from a single mass of material or they are milled or carved from a larger block of material. An alternative approach to manufacture objects is to deposit a thin layer of material, as a powder, and then add another layer on top, followed by another and another, and so on. This process of adding gave rise to the name additive manufacturing (AM), more commonly known as 3D printing. The range of specially designed 3D-printed products on the market is now considerable—from motor parts to dental implants. They can be notably manufactured using plastics. It is expected that additive manufacturing will disrupt established practices and overturn conventional assumptions about mass production in distant factories. Local fabrication in small volumes, or even of single items, close to the end user will become viable.

One of the fundamental limitations associated with known AM methods using polymeric part material in the form of a powder is based on the lack of identification of a material which presents the right set of properties in order to print 3D parts/objects with acceptable density and mechanical properties.

Poly(arylene sulfide) (PAS) polymers are semi-crystalline thermoplastic polymers having notable mechanical properties, such as high tensile modulus and high tensile strength, and remarkable stability towards thermal degradation and chemical reactivity. They are also characterized by excellent melt processing, such as injection molding.

This broad range of properties makes PAS polymers suitable for a large number of applications, for example in the automotive, electrical, electronic, aerospace and appliances markets.

Despite the above advantages, PAS polymers are known to present a low impact resistance and a low elongation at break, in other words a poor ductility and a poor toughness.

Therefore there is a need for a PAS polymer for use in additive manufacturing which has improved ductility and toughness, while maintaining high tensile strength.

WO 2017/1226484 (Toray) describes the use of PAS resins as a powder for producing a 3D model by a 3D printer with powder sintering.

WO 2020/011991 (Solvay) relates to a PAS polymer which can be used in AM. This PAS is such that it exhibits, as a main technical feature, a calcium content of less than 200 ppm, as measured by X-ray Fluorescence (XRF) analysis calibrated with standards via ICP-OES.

WO 2020/011990 (Solvay) describes a PAS polymer which presents a flowability which makes the powder well-suited for applications such as the manufacture of 3D objects using a laser-sintering based AM system in which the powder has to present good flow behaviors in order to facilitate the packing of the powder during the printing process.

These documents do not describe a powdered material for use in AM comprising a PAS polymer as described herein. The use of such material is shown to lead to better printing characteristics and improved final part properties (mechanical and part aesthetics) than the powder of the prior art.

### DISCLOSURE OF THE INVENTION

Disclosed herein are powdered materials (M), as well as a process for manufacturing a 3D object (i.e. article, part or composite material) from such powdered materials (M) comprising at least one poly(arylene sulfide) polymer, also referred to herein as “poly(arylene sulfide)” or PAS. Reference to poly(arylene sulfide) polymer specifically includes, without limitation, polyphenylene sulfide polymer also referred to herein as “polyphenylene sulphide” or PPS.

The powdered material (M) of the present invention can have a regular shape such as a spherical shape, or a complex shape obtained by grinding/milling of the polymeric component (P), i.e. at least the PAS polymer, in the form of pellets or coarse powder.

In the present description, unless otherwise indicated, the following terms are to be meant as follows.

The expression “sulfide moiety” is intended to denote the —S— bridge of the recurring units p in formula (I).

The expression “sulfoxide moiety” is intended to denote the —SO— bridge of the recurring units q in formula (I).

The expression “sulfone moiety” is intended to denote the —SO₂— bridge of the recurring units r in formula (I).

The expression “oxidized moieties” is more general and is intended to denote both the sulfoxide moieties and the sulfone moieties.

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

In a first aspect, the present invention relates to a powdered material (M) containing a poly(arylene sulfide) (PAS) polymer, said PAS polymer comprising recurring units p, q and r according of formula (I):

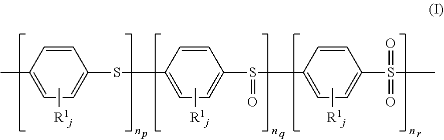

wherein
nₚ, n_{q} and nᵣ are respectively the mole % of each recurring units p, q and r; recurring units p, q and r are arranged in blocks, in alternation or randomly;

2%≤(n_{q}+nᵣ)/(nₚ+n_{q}+nᵣ)≤9%;

n_{q} is ≥0% and nᵣ is ≥0%;
j is zero or an integer varying between 1 and 4;
R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

Powdered Material (M)

The powdered material (M) of the present invention comprises at least one polymeric component (P). The polymeric component (P) of the powdered material (M) may comprise one or several PAS as described below. It may also comprise at least one additional polymeric material, that-is-to-say at least one polymer or copolymer, distinct from the PAS polymer described herein. This additional polymeric material may for example be selected from the group consisting of poly(aryl ether sulfone) (PAES) polymers, for example a poly(biphenyl ether sulfone) (PPSU) polymer or a polysulfone (PSU) polymer, and a poly(aryl ether ketone) (PAEK) polymers, for example a poly(ether ether ketone) (PEEK) polymer. This additional polymeric material may also be a poly(arylene sulphide) (PAS*) distinct from the PAS described herein, for example a homopolymer of poly(phenylene sulphide) (PPS) polymer.

The PAS described herein comprises recurring units p, q and r according of formula (I):

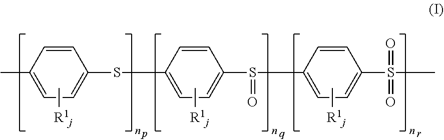

wherein the recurring units p, q and r are arranged in blocks, in alternation or randomly.

In formula (I), j is zero or an integer varying between 1 and 4.

Preferably, j is zero in formula (I), which means that the aromatic ring is unsubstituted. Accordingly, recurring units p, q and r are, respectively, according to formulas (II), (III) and (IV) below:

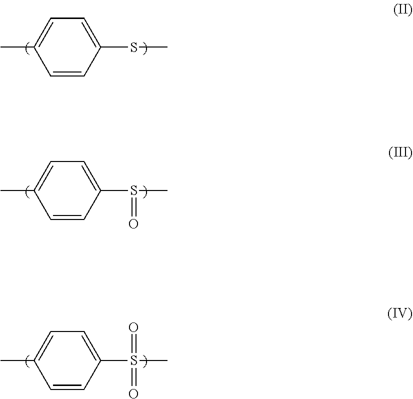

When j varies between 1 and 4, R¹ can be selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

The molar percentage of recurring units p, q and r in formula (I), respectively noted nₚ, n_{q} and nᵣ, is such that 2%≤(n_{q}+nᵣ)/(nₚ+n_{q}+nᵣ)≤9%, which means that the PAS polymer of formula (I) comprises between 2 and 9 mol. % of oxidized recurring units q and r, based on the total number of recurring units p, q and r in the polymer.

The PAS polymer described herein comprises recurring units p, and it comprises recurring units q and/or r. When the PAS polymer comprises recurring units p, q and r, both n_{q} and nᵣ in the above equation are >0%. Alternatively, the PAS polymer described herein may comprise recurring units p and q but no recurring units r. In this case n_{q} is ≥2%, but nᵣ=0%. According to a third possibility, the PAS polymer described herein may comprise recurring units p and r but no recurring units q. In this case nᵣ is ≥2%, but n_{q}=0%.

In some embodiments, the molar percentage of recurring units p, q and r in formula (I) is such that:

2.2%≤(n_{q}+nᵣ)/(nₚ+n_{q}+nᵣ)≤8.8% or

2.5%≤(n_{q}+nᵣ)/(nₚ+n_{q}+nᵣ)≤8.5% or

2.8%≤(n_{q}+nᵣ)/(nₚ+n_{q}+nᵣ)≤8.2% or

3.0%≤(n_{q}+nᵣ)/(nₚ+n_{q}+nᵣ)≤7.0%

According to an embodiment, the sum nₚ+n_{q}+nᵣ is at least 50%, which means that the PAS comprises at least 50 mol. % of recurring units p, q and r, based on the total number of moles of recurring units in the PAS polymer. For example, the sum nₚ+n_{q}+nᵣ can be at least 60%, at least 70%, at least 80%, at least 90% or even at least 95%, based on the total number of moles of recurring units in the PAS polymer.

According to an embodiment described herein, the PAS consists of, or consists essentially of, recurring units p, as well as recurring units q and/or r. The expression “consists essentially of” means that the PAS comprises recurring units p, and recurring units q and/or r, as well as less than 10 mol. %, preferably less than 5 mol. %, more preferably less than 3 mol. %, even more preferably less than 1 mol. %, of other recurring units distinct from recurring units p, q and r, based on the total number of moles of recurring units in the PAS polymer.

According to an embodiment, the PAS polymer described herein further comprises recurring units s and/or t, respectively, of formula (V) and/or (VI):

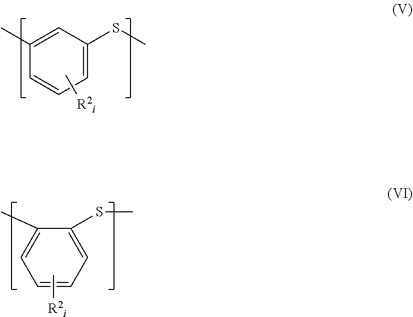

wherein:
i is zero or an integer varying between 1 and 4;
R² is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

In formulas (V) and (VI), i is preferably zero, which means that the aromatic rings are unsubstituted.

The sum nₛ+nₜ is less than 10 mol. %, preferably less than 5 mol. %, more preferably less than 3 mol. %, even more preferably less than 1 mol. %, based on the total number of moles of recurring units in the PAS polymer.

According to an embodiment, the sum nₚ+n_{q}+nᵣ is 100%, with at least one of n_{q} and nᵣ>0 mol. %.

According to an embodiment, the sum nₚ+n_{q}+nᵣ is less than 100%. In this embodiment, the PAS polymer comprises at least one recurring unit distinct from p, r and q, for example recurring units according to formulas (V) and/or (VI).

According to another embodiment, the sum nₚ+n_{q}+nᵣ+nₛ+nₜ is 100%, with at least one of n_{q} and nᵣ>0 mol. % and at least one of nₛ and nₜ>0 mol. %.

Preferably, the PAS has a melt flow rate (at 315.6° C. under a weight of 1.27 kg according to ASTM D1238, procedure B) of at most 700 g/10 min, more preferably of at most 500 g/10 min, even more preferably of at most 200 g/10 min, still more preferably of at most 50 g/10 min, yet more preferably of at most 35 g/10 min.

Preferably, the PAS has a melt flow rate (at 315.6° C. under a weight of 1.27 kg according to ASTM D1238, procedure B) of at least 1 g/10 min, more preferably of at least 5 g/10 min, even more preferably of at least 10 g/10 min, still more preferably of at least 15 g/10 min.

Preferably, the PAS has a melting point of at least 240° C., more preferably of at least 248° C., even more preferably of at least 250° C., when determined on the 2^{nd} heat scan in differential scanning calorimeter (DSC) according to ASTM D3418, using heating and cooling rates of 20° C./min.

Preferably, the PAS has a melting point of at most 280° C., more preferably of at most 278° C., even more preferably of at most 275° C., when determined on the 2^{nd} heat scan in differential scanning calorimeter (DSC) according to ASTM D3418, using heating and cooling rates of 20° C./min.

In some embodiments, the PAS has a heat of fusion of more than 20 J/g, determined on the 2^{nd} heat scan in differential scanning calorimeter (DSC) according to ASTM D3418, using heating and cooling rates of 20° C./min, preferably more than 21 J/g or more than 22 J/g.

The powdered material (M) of the present invention comprises one polymeric component (P) comprising at least one PAS polymer as described above. The powdered material (M) of the present invention may consist essentially in one or several polymers, for example it may consist essentially in one PAS polymer as described herein, or it may also comprise further components, for example a flow aid/agent (F), as described below, and/or one or several additives (A). When the powdered material (M) of the invention comprises additional components, they can be added or blended with the polymeric component described herein before, during or after the step of grinding.

In some embodiments of the present invention, the powdered material (M) has a d₉₀-value less than 150 μm, as measured by laser scattering in isopropanol. According to an embodiment, the powdered material (M) has a d₉₀-value less than 120 μm, as measured by laser scattering in isopropanol, preferably less than 110 μm or less 100 μm.

In some embodiments of the present invention, the powdered material (M) has a d₁₀-value higher than 0.1 μm, as measured by laser scattering in isopropanol. According to a preferred embodiment, the powdered material (M) has a d₁₀-value higher than 1 μm, as measured by laser scattering in isopropanol, preferably higher than 5 μm or higher than 10 μm.

In some embodiments of the present invention, the powdered material (M) has a d₅₀-value comprised between 40 μm and 70 μm, as measured by laser scattering in isopropanol, preferably between 40 μm and 60 μm, or between 43 μm and 58 μm or between 45 μm and 55 μm. A powdered material (M) with such particle size distribution is for example well-suited for selective laser sintering (SLS).

In some embodiments of the present invention, the powdered material (M) has a d₉₉-value less than 195 μm, as measured by laser scattering in isopropanol. According to a preferred embodiment, the powdered material (M) has a d₉₉-value less than 190 μm, as measured by laser scattering in isopropanol, preferably less than 180 μm or less than 170 μm.

The powdered material (M) of the present invention may have a BET surface area ranging from 0 to 30 m²/g, preferably from 0.5 to 20 m²/g, more preferably from 0.8 to 15 m²/g, as measured by ISO 9277, using a soak/evacuation temperature of at most 25° C.

The powdered material (M) of the present invention may have a bulk density (or poured bulk density) of at least 0.35, preferably at least 0.45, most preferably at least 0.50. The bulk density is at most 5.

According to one embodiment, the powdered material (M) of the present invention comprises at least 50 wt. % of the polymeric component (P), for example at least 60 wt. % of the polymeric component (P), at least 70 wt. %, at least 80 wt. %, at least 90 wt. %, at least 95 wt. %, at least 98 wt. % or at least 99 wt. % of the polymeric component (P) described herein, based on the total weight of the powdered material (M).

According to one embodiment, the polymeric component (P) comprises at least 50 wt. % of the PAS described herein, for example at least 60 wt. % of the PAS described herein, at least 70 wt. %, at least 80 wt. %, at least 90 wt. %, at least 95 wt. %, at least 98 wt. % or at least 99 wt. % of the PAS described herein described herein, based on the total weight of the powder.

Additional components may notably be added to the polymeric component (P), before, during or after the step grinding of the polymeric component (P), notably the step grinding of the PAS described herein, before the use of the powder for additive manufacturing. For example, the additional component may be a flow agent (F). This flow agent (F) may for example be hydrophilic. Examples of hydrophilic flow aids are inorganic pigments notably selected from the group consisting of silicas, aluminas and titanium oxide. Mention can be made of fumed silica. Fumed silicas are commercially available under the trade name Aerosil® (Evonik) and Cab-O-Sil® (Cabot). Fumed aluminas are commercially available under the trade name SpectraAI® (Cabot).

In one embodiment of the present invention, the powdered material (M) comprises from 0.01 to 10 wt. % of a flow agent (F), for example from 0.05 to 8 wt. %, from 0.1 to 6 wt. % or from 0.15 to 5 wt. % of at least one flow agent (F), for example of at least fumed silica or fumed alumina, based on the total weight of the powder.

These silicas or aluminas are composed of nanometric primary particles (typically between 5 and 50 nm for fumed silicas or aluminas). These primary particles are combined to form aggregates. In use as flow agent, silicas or aluminas are found in various forms (elementary particles and aggregates).

The powdered material (M) of the present invention may also comprise one or several additives (A), for example selected from the group consisting of fillers (such as carbon fibers, glass fibers, milled carbon fibers, milled glass fibers, glass beads, glass microspheres, wollastonite, silica beads, talc, calcium carbonates) colorants, dyes, pigments, lubricants, plasticizers, flame retardants (such as halogen and halogen free flame retardants), nucleating agents, heat stabilizers, light stabilizers, antioxidants, processing aids, fusing agents and electromagnetic absorbers. Specific examples of these optional additives (A) are titanium dioxide, zinc oxide, cerium oxide, silica or zinc sulphide, glass fibers, carbon fibers.

The powdered material (M) of the present invention may also comprise flame retardants, such as halogen and halogen free flame retardants.

In another embodiment of the present invention, the powdered material (M) comprises from 0.01 to 30 wt. % of at least one additive (A), for example from 0.05 to 25 wt. %, from 0.1 to 20 wt. % or from 0.15 to 10 wt. % of at least one additive (A), based on the total weight of the powder.

According to one embodiment, the powdered material (M) of the present invention comprises:
at least 50 wt. % of the polymeric component (P),
from 0.01 wt. % to 10 wt. %, from 0.05 to 8 wt. %, from 0.1 to 6 wt. % or from 0.15 to 5 wt. % of at least one flow agent (F), and
optionally at least one additive (A), for example selected from the group consisting of fillers (such as carbon fibers, glass fibers, milled carbon fibers, milled glass fibers, glass beads, glass microspheres, wollastonite, silica beads, talc, calcium carbonates) colorants, dyes, pigments, lubricants, plasticizers, flame retardants (such as halogen and halogen free flame retardants), nucleating agents, heat stabilizers, light stabilizers, antioxidants, processing aids, fusing agents and electromagnetic absorbers, the % being based on the total weight of the powder.

The PAS polymer described herein may be prepared by a process comprising a step of oxidizing solid particles of a poly(arylene sulfide) (PAS-p) of formula (VII):

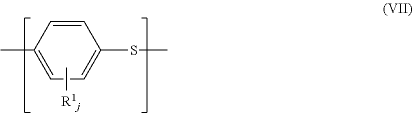

wherein:
j is zero or an integer varying between 1 and 4;
R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, wherein said step of oxidation takes place in a liquid containing an oxidizing agent.

The oxidizing agent is used in an amount such that from 2 to 9 mol. % of the sulfide moieties of the PAS-p are oxidized into sulfoxide moieties and/or sulfone moieties, thus providing the PAS described above. The liquid advantageously contains the oxidizing agent in an amount from 2 to 9 mol. % of the sulfide moieties in the PAS-p polymer. Said liquid may, for example, contain acetic acid. Said oxidizing agent may, for example, be hydrogen peroxide. Said liquid may also, for example, contain a peracid formed by reaction of acetic acid and hydrogen peroxide.

The present invention is also directed to a process for producing the powdered material (M) for the use in a method for a layer-wise manufacturing of a three-dimensional part, in which the fine powder is manufactured by grinding, a precipitation process from a solvent, melt spraying or spray drying from a coarse powder or granulate.

The powdered material (M) employed in the additive manufacturing process of the present invention may be obtained by:
Step 1′) grinding the polymeric component (P), notably grinding the PAS polymer described herein; and
Step 2′) blending the polymeric component (P) from Step 1′) with the optional components, e.g. at least one flow agent (F).

The powdered material (M) employed in the additive manufacturing process of the present invention may alternatively be obtained by:
Step 1″) blending the polymeric component (P) with the optional components, e.g. at least one flow agent (F), and
Step 2″) grinding the blend from Step 1″), notably grinding the PAS polymer described herein.

The grinding step can take place in a pinned disk mill, a jet mill/fluidized jet mil with classifier, an impact mill plus classifier, a pin/pin-beater mill or a wet grinding mill, or a combination of those equipment.

The ground powdered material can be separated or sieved, preferably in an air separator or classifier, to obtain a predetermined fraction spectrum. The powdered material (M) is preferably sieved before use in the printer. The sieving consists in removing particles bigger than 200 μm, than 150 μm, than 140 μm, 130 μm, 120 μm, 110 μm, or bigger than 100 μm, using the appropriate equipment.

According to another aspect, the present invention relates to a process for manufacturing a three-dimensional (3D) article, part or composite material, comprising depositing successive layers of a powdered material (M) and selectively sintering each layer prior to deposition of the subsequent layer, for example by means of an electromagnetic radiation of the powder.

The additive manufacturing process of the present invention is preferably selected from the group consisting of selective laser sintering (SLS), composite-based additive manufacturing technology (“CBAM”) or multi jet fusion (MJF).

The additive manufacturing process usually takes place using a 3D printer.

SLS 3D printers are, for example, available from EOS Corporation under the trade name EOSINT® P.

MJF 3D printers are, for example, available from Hewlett-Packard Company under the trade name Multi Jet Fusion.

The powder may also be used to produce continuous fiber composites in a CBAM process, for example as developed by Impossible Objects.

According to an embodiment, the step of printing layers comprises the selective sintering of the powdered material (M) by means of an electromagnetic radiation of the powdered material (M), for example a high power laser source such as an electromagnetic beam source.

The 3D object/article/part may be built on substrate, for example an horizontal substrate and/or on a planar substrate. The substrate may be moveable in all directions, for example in the horizontal or vertical direction. During the 3D printing process, the substrate can, for example, be lowered, in order for the successive layer of unsintered polymeric material to be sintered on top of the former layer of sintered polymeric material.

According to an embodiment, the process further comprises a step consisting in producing a support structure. According to this embodiment, the 3D object is built upon the support structure and both the support structure and the 3D object are produced using the same AM method. The support structure may be useful in multiple situations. For example, the support structure may be useful in providing sufficient support to the printed or under-printing, in order to avoid distortion of the shaped 3D object, especially when this 3D object is not planar. This is particularly true when the temperature used to maintain the printed or under-printing, 3D object is below the re-solidification temperature of the polymeric component, e.g. PAS polymer.

The 3D printer may comprise a sintering chamber and a powder bed, both maintained at determined at a specific temperature.

The powdered material (M) to be printed can be pre-heated to a processing temperature (Tp), above the glass transition (Tg) temperature of the powder, and below the melting temperature (Tm). The preheating of the powdered material (M) makes it easier for the laser to raise the temperature of the selected regions of layer of unfused powder to the melting point. The laser causes fusion of the material only in locations specified by the input. Laser energy exposure is typically selected based on the polymer in use and to avoid polymer degradation.

The inventors have realized that printing the powdered material (M) of the present invention comprising the modified PAS can take place at a processing temperature (Tp) which is lower than the processing temperature of a powdered material (M) comprising unmodified PAS. This is advantageous as it positively impacts the energy consumption.

Article and Applications

The present invention also relates to an article, part or composite material comprising the poly(arylene sulfide) (PAS) as described herein obtainable from the additive manufacturing process of the present invention, and to the use of said article, part or composite material in oil and gas applications, automotive applications, electric and electronic applications, or aerospace and consumer goods.

With respect to automotive applications, said articles can be pans (e.g. oil pans), panels (e.g. exterior body panels, including but not limited to quarter panels, trunk, hood; and interior body panels, including but not limited to, door panels and dash panels), side-panels, mirrors, bumpers, bars (e.g., torsion bars and sway bars), rods, suspensions components (e.g., suspension rods, leaf springs, suspension arms), and turbo charger components (e.g. housings, volutes, compressor wheels and impellers), pipes (to convey for example fuel, coolant, air, brake fluid). With respect to oil and gas applications, said articles can be drilling components, such as downhole drilling tubes, chemical injection tubes, undersea umbilicals and hydraulic control lines. Said articles can also be mobile electronic device components.

According to an embodiment, the composite material obtainable from the additive manufacturing process of the present invention is a continuous fibers reinforced thermoplastics composite. The fibers may be composed of carbon, glass or organic fibers such as aramid fibers.

The present invention also relates to the use of the powdered material (M) described herein, for the manufacture of a three-dimensional (3D) object using additive manufacturing, preferably selective laser sintering (SLS), composite-based additive manufacturing technology (“CBAM”) or multi jet fusion (MJF).

The present invention also relates to the use of a polymeric component (P) comprising at least one poly(arylene sulfide) (PAS) polymer, as described above, for the manufacture of a powdered material (M) for additive manufacturing, preferably selective laser sintering (SLS), composite-based additive manufacturing technology (“CBAM”) or multi jet fusion (MJF).

The invention will now be described with reference to the following examples, whose purpose is merely illustrative and not intended to limit the scope of the invention.

### EXPERIMENTAL SECTION

Materials

Ryton® QA200N is a poly(phenylene sulfide) commercially available from Solvay Specialty Polymers USA.

Hydrogen peroxide 30% w/w aqueous solution was purchased from Fischer.

Acetic acid with purity of 99% was purchased from VWR.

### Synthesis Example

PAS Polymer #1 (Inventive)

Ryton® QA200N (200 g, 1.0 eq) was suspended in acetic acid (400 mL) under a nitrogen atmosphere inside a 1 L reactor equipped with an inclined quadripale type stirrer, a condenser, a double jacket for heating and a syringe pump.

The resulting suspension was stirred at room temperature and hydrogen peroxide 30% w/w (6.0 g, 0.03 eq) was added via syringe pump over a period of 15 minutes.

The temperature was raised to 70° C. (double jacket set at 75° C.) and the reaction mixture was stirred for 3 hours at this temperature. The stirring speed was set to 300 rpm. Then, an analysis of the supernatant with Quantofix peroxide test sticks confirmed the absence of peroxide.

The reaction mixture was then cooled to room temperature and filtered. The recovered solids were washed twice with acetic acid at room temperature (2×100 mL). The solids were then dried in a rotating evaporator under a pressure of 20 mbar and at a temperature of 50° C. for 2 hours. The recovered solids were than dried under vacuum (˜20 mbar) at 120° C. for 7 hours.

The obtained product is a poly(phenylene sulfide) of formula (I), wherein j=0, nₚ=96%, n_{q}+nᵣ=4%. Accordingly, under these conditions 4 mol. % of the sulfide moieties of Ryton® QA200N have been oxidized into sulfoxide and sulfone moieties.

Characterization of the Polymeric Component

DSC/Heat of Fusion

DSC analyses were carried out on DSC Q200-5293 TA Instrument according to ASTM D3418 and data was collected through a two heat, one cool method. The protocol used is the following: 1st heat cycle from 30.00° C. to 350.00° C. at 20.00° C./min; isothermal for 5 minutes; 1st cool cycle from 350.00° C. to 30.00° C. at 20.00° C./min; 2^{nd} heat cycle from 30.00° C. to 350.00° C. at 20.00° C./min. The melting temperature (Tₘ) is recorded during the 1^{st} and 2^{nd} heat cycles, the melt crystallization temperature (T_{mc}) is recorded during the cool cycle, the glass transition temperature (T_{g}) is recorded during the 2^{nd} heat cycle, and the enthalpy of melting (ΔH) is recorded during the 2^{nd} heat cycle.

Grinding of the Polymeric Components—Preparation of the Powdered Materials

Ryton® QA200N (comparative) and PAS polymer #1 (inventive) were turned into powders by milling on a rotor attrition mill (Retsch Rotor Mill SR300) and characterized. Results are presented in Table 1.

The powders were then blended with 0.3% fumed silica (Cab-O-Sil® M-5 from Cabot Corporation) via drum rolling and sieved through No. 120 mesh tensile bolting cloth (pore size of 147 μm).

PSD

Particle size (d₁₀, d₅₀ and d₉₀) was determined on the final powders by an average of 3 runs via a laser scattering technique on a Microtrac S3500 analyzer in wet mode (128 channels, between 0.0215 and 1408 μm). The solvent used was isopropanol with a refractive index of 1.38, with the particles assumed to have a refractive index of 1.59. The ultrasonic mode was enabled (25 W/60 seconds) and the flow was set at 55%. Results are presented in Table 2 below.

BET Surface Area and Bulk Density

BET surface area (multi-point) of the final powders was determined on a TriStar II Plus Version 3.01 surface area and pore analyzer via nitrogen (N2) gas adsorption according to ISO 9277. Bulk density of the powders was determined via Method A of ASTM D1895. Results are presented in Table 2 below.

TABLE 1

| | Oxidized | | | Tₘ | Tm | |
|---|---|---|---|---|---|---|
| | moieties | T_{g} | T_{mc} | 2^{nd} heat | 1^{st} heat | ΔH |
| | [mol. %] | (° C.) | (° C.) | (° C.) | (° C.) | (J · g⁻¹) |
| Ryton ® | 0 | 94.6 | 226.9 | 279.6 | 289.4 | 50.9 |
| QA200N | | | | | | |
| PAS | 4 | 100.9 | 150.1 | 252.3 | 285.3 | 23.1 |
| polymer #1 | | | | | | |

TABLE 2

| | BET Surface | Bulk Density | PSD |
|---|---|---|---|
| | Area (m²/g) | (g/cm³) | (microns) |
| Comparative | 1.83 | 0.64 | d₁₀: 33 |
| powder (based on | | | d₅₀: 50 |
| Ryton ® QA200N) | | | d₉₀: 79 |
| Inventive powder | 3.82 | 0.67 | d₁₀: 30 |
| (based on PAS | | | d₅₀: 48 |
| polymer #1) | | | d₉₀: 78 |

Printing

Printing occurred on an EOSINT® P800 SLS Printer, using the following print settings: hatch laser power of 17 watts, contour laser power of 8.5 watts, laser speed of 2.65 m/s, and cooling rate after print completion of less than 10° C./min.

The powdered materials were sintered into ASTM Type I tensile bars.

Characterization of the Printed Bars

The ASTM Type I tensile bars were tested according to ASTM D638, where the result reported in Table 3 is an average from 5 bars.

Results

TABLE 3

| | | | Ultimate | Tensile |
|---|---|---|---|---|
| | | Processing | Tensile | Elongation |
| | PSD | Temperature | Strength | at Break |
| Example | (microns) | (° C.) | (MPa) | (%) |
| Comparative | d₁₀: 33 | 275 | 48 | 1.4 |
| powder (based on | d₅₀: 50 | | | |
| Ryton ® QA200N) | d₉₀: 79 | | | |
| Inventive powder | d₁₀: 30 | 263 | 55 | 2.4 |
| (based on PAS | d₅₀: 48 | | | |
| polymer #1) | d₉₀: 78 | | | |

The powder comprising unmodified PPS Ryton® QA200N (comparative powder) was first printed at a processing temperature of 263° C., but this led to curling. The processing temperature of the comparative powder was thus adjusted to 275° C. to avoid curling. The powder based on the inventive PAS polymer #1 was printed at a processing temperature of 263° C. and no curling occurred.

The inventive powder demonstrated better printing characteristics and final resulting printed part properties (mechanical and part aesthetics) than the comparative powder. During the print, the inventive powder demonstrated a smooth bed surface during the entire print. This is critical towards obtaining a stable print that will result in a successful print completion and acceptable parts.

The bars printed from the inventive powder exhibited smooth surfaces.

The use of the inventive powder resulted in parts with mechanical properties (both ultimate tensile strength and tensile elongation at break) superior to that of the unmodified Ryton® QA200N.

1-15. (canceled)

16. A powdered material (M) for additive manufacturing, comprising:
one polymeric component (P) comprising at least one poly(arylene sulfide) (PAS) polymer, comprising recurring units p, q and r according of formula (I): 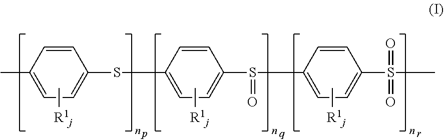
nₚ, n_{q} and nᵣ are respectively the mole % of each recurring units p, q and r;
recurring units p, q and r are arranged in blocks, in alternation or randomly;
2%≤(n_{q}+nᵣ)/(nₚ+n_{q}+nᵣ)≤9%; n_{q} is ≥0% and nᵣ is ≥0%;
j is zero or an integer varying between 1 and 4;
R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups,
optionally one or several flow agent(s) (F),
optionally one or several additive(s) (A) selected from the group consisting of lubricants, heat stabilizers, light stabilizers, antioxidants, pigments, processing aids, dyes, fillers, nanofillers or electromagnetic absorbers and flame retardants.

17. The powdered material (M) of claim 16, wherein the PAS is such that nₚ+n_{q}+nᵣ≥50%.

18. The powdered material (M) of claim 16, wherein the PAS is such that it consists essentially of recurring units p, and recurring units q and/or r.

19. The powdered material (M) of claim 16, wherein the PAS is such that j is zero in formula (I).

20. The powdered material (M) of claim 16, wherein the PAS has a heat of fusion of more than 20 J/g, determined on the 2^{nd} heat scan in differential scanning calorimeter (DSC) according to ASTM D3418, using heating and cooling rates of 20° C./min.

21. The powdered material (M) of claim 16, wherein the PAS is such that it has a melting point of at most 280° C., and/or of at least 240° C., when determined on the 2^{nd} heat scan in differential scanning calorimeter (DSC) according to ASTM D3418, using heating and cooling rates of 20° C./min.

22. The powdered material (M) of claim 16, wherein the flow agent (F) is an inorganic pigment selected from the group consisting of silicas, aluminas and titanium oxide.

23. The powdered material (M) of claim 16, wherein the flow agent (F) is fumed silica.

24. The powdered material (M) of claim 16, wherein the material (M) has a d_{0.5}-value ranging between 15 and 80 μm, as measured by laser scattering in isopropanol.

25. A process for manufacturing a three-dimensional (3D) article, part or composite material, comprising:
a) depositing successive layers of a powdered material (M) of claim 16, and
b) printing layers prior to deposition of the subsequent layer.

26. The process of claim 25, wherein step b) comprises selective sintering by means of an electromagnetic radiation of the powder.

27. A three-dimensional (3D) article, part or composite material obtained by additive manufacturing from the powdered material (M) of claim 16.

28. A method for manufacturing a three-dimensional (3D) object, the method comprising using the powdered material (M) of claim 16 in an additive manufacturing process to form the three-dimensional (3D) object.

29. A method for manufacturing a powdered material (M), the method comprising using a polymeric component (P) comprising at least one poly(arylene sulfide) (PAS) polymer, comprising recurring units p, q and r according of formula (I): 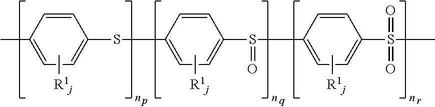
wherein
nₚ, n_{q} and nᵣ are respectively the mole % of each recurring units p, q and r;
recurring units p, q and r are arranged in blocks, in alternation or randomly;
2%≤(n_{q}+nᵣ)/(nₚ+n_{q}+nᵣ)≤9%; n_{q} is ≥0% and nᵣ is ≥0%;
j is zero or an integer varying between 1 and 4;
R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups,
optionally in combination with one or several flow agent(s) (F) and/or one or several additives (A),
to manufacture the powdered material (M).

30. A method for using the article, part or composite material of claim 27, the method comprising using the article, part or composite in an oil and gas application, an automotive application, an electric and electronic application, or aerospace and consumer goods application.
